(19) United States
(12) Patent Application Publication
(10) Pub. No.: US 2004/0178359 A1
(43) Pub. Date: Sep. 16, 2004

(54) Methods of measuring and evaluating amount of bran and apparatus for measuring the same

(76) Inventors: Shigeharu Kanemoto, Tokyo (JP); Hiroyuki Maehara, Tokyo (JP); Hisahiko Watanabe, Tokyo (JP); Hideki Ushio, Tokyo (JP)

Correspondence Address: STAAS & HALSEY LLP, SUITE 700, 1201 NEW YORK AVENUE, N.W., WASHINGTON, DC, 20005, US

(21) Appl. No.: 10/759,226

(22) Filed: Jan. 20, 2004

(30) Foreign Application Priority Data
Feb. 14, 2003 (JP) 037253/2003

(51) Int. Cl. G01N 21/64

(52) U.S. Cl. 250/461.1

(57) ABSTRACT

Rice washing water is exposed to ultraviolet light so that ferulic acid in the rice washing water is excited by the ultraviolet light to emit fluorescence. Then the intensity of fluorescence emitted by the ferulic acid in the rice washing water is measured and the measured values are used as an index to judge the amount of bran in the rice washing water. Preferably the wave length of the ultraviolet light is set to fall in the range of 330 to 340 nm and the wave length of the fluorescence, whose intensity is to be measured, is set to fall in the range of 430 to 450 nm.

### BACKGROUND OF THE INVENTION

1. Field of the Invention

The present invention relates to a technique for measuring the amount of bran remaining on rice grains.

2. Description of the Related Art

Measuring the amount of bran remaining on rice grains is significant for grasping the degree of rice polishing in controlling rice polishing, or for grasping the degree of bran removing of non-bran rice (which means rice grains from which bran has been removed to such an extent that they need not be washed with water before cooked) and using the information to control or evaluate (grade) non-bran rice processing.

There have been methods for measuring the amount of bran remaining on polished rice (1) in which the turbidity is measured of the rice washing water obtained after washing the polished rice grains (rice washing water obtained by stirring the sample rice together with water) and (2) in which solid matter is taken out of rice washing water obtained after washing the polished rice grains and the weight of the solid matter (amount of dried residue) is measured.

According to one example of the methods (1) in which the turbidity is measured, 20 gram of a polished rice sample is put into an Erlenmeyer flask, 200 ml of water is poured into the flask, and the flask with a rubber stopper added thereto is shaken with a shaker (product of Yamato Science, Model SA-31A etc.) for 10 minutes (144 to 150 cycles/min). Fifty ml of the resultant rice washing water is diluted by 10 times its volume of water and the turbidity is measured with a turbidimeter (product of Noda Tsushin, Model M-204 etc.). The measurement is repeated 3 times and the average value is used as the turbidity.

The rice washing machine disclosed in Japanese Patent Application Laid-Open No. 5-115802 uses the turbidity obtained by the above described method for determining the rice washing conditions (time required for rice washing, the number of times rice washing is done) to control its rice washing processing.

The method (2) in which the weight of dried residue is measured is often used to judge the amount of bran remaining on non-bran rice. According to one example of this method, 100 gram of non-bran rice is put into an Erlenmeyer flask, 150 ml of water is poured into the flask, and the flask is shaken for 40 seconds (about 100 times). The resultant rice washing water is taken into a beaker, and exactly 25 ml of the same is taken, while stirring, into an aluminum weighing can (2 cans of rice washing water per sample non-bran rice). Then each rice washing water is dried with a drier, left cooled in a desiccator, and weighed to obtain the amount of the dried residue.

However, in the conventional measurements of the turbidity of rice washing water and the amount of dried residue, the substances in rice washing water have not been specified and the turbidity due to and the weight of the grains of all the substances suspended in rice washing water have been measured. Thus, it cannot be said that the measurements have grasped the amount of testa, pericarp and aleurone layer, which constitute bran, with high precision. Specifically, in rice washing water, starch granules of starch reserving cells which have been exposed by rice polishing are suspended, and the influence of such a substance on the measurements is not negligible, and moreover, the rate of such starch granules differs dependent upon the yield of polished rice.

### SUMMARY OF THE INVENTION

The object of the present invention is to provide a method of specifying bran contained in rice washing water and measuring the amount of the bran so that the amount of bran remaining on sample rice (polished rice, non-bran rice, etc.) with high precision; a method of evaluating the amount of bran remaining on sample rice; and an apparatus for carrying out these methods.

There exists ferulic acid (4-hydroxy-3-methoxycinnamic acid) specifically in testa, pericarp and aleurone layer, which constitute bran, whereas starch reserving cells contain no ferulic acid. Ferulic acid emits fluorescence when exposed to ultraviolet light and the intensity of the fluorescence becomes high in a specific wavelength range (the fluorescence has a peak in a specific wavelength range). Further, the difference of the intensity of fluorescence based on the amount of bran is so great that a sufficient resolving power is given as a measured value of the amount of bran. The present invention makes use of the above described characteristics of bran.

FIGS. 1 and 2 illustrate the above phenomenon in a concrete form. FIG. 1 shows the intensity of fluorescence emitted from each of 5 different samples, which were prepared by adding 5 times the volume of water to 10 gram of polished rice (sample rice), recovering the supernatant of the mixture after stirring the same for 10 seconds and dividing the supernatant into 5 (supernatant liquids), when the samples were exposed to ultraviolet light with different wave lengths (300, 310, 320, 330, 350 nm). In FIG. 2, the same sample rice was repeatedly washed 4 times, the supernatant liquid obtained at each of four washing times was irradiated with ultraviolet light having a wave length of 340 nm, and then the intensity of fluorescence in the wave length range of 380 to 560 nm, emitted from each of four different supernatant liquids, was plotted. In the graphs shown in FIGS. 1 and 2, the vertical axis represents an intensity of fluorescence (unit: A.U), and the horizontal axis represents a wave length (unit: nm) of the fluorescence.

As is evident from the graphs shown in FIG. 1, the spectrum of the intensity of fluorescence has a peak at a wavelength of about 440 nm, regardless of the exciting wave length of ultraviolet light. As this phenomenon is peculiar to ferulic acid, the presence of ferulic acid is easy to recognize. In addition, measuring the intensity of fluorescence at the peak position allows the errors arising in measurement to be relatively reduced.

As is evident from the graph shown in FIG. 2, the intensity of fluorescence emitted from the supernatant caused by the first rice washing is greatly different from the intensity of fluorescence emitted from the supernatant caused by the second or third rice washing, in the range of 440 to 460 nm in fluorescent wavelength. This agrees with the fact that almost all the bran on the sample rice is removed by the first rice washing, there remains only about one fifth of the original bran at the second rice washing and that there exists almost no bran on the sample rice at and after the third rice washing. In other words, this graph explains that if ultraviolet light having wave lengths of 330 to 340 nm is used as irradiating light and fluorescence having wave lengths of 440 to 460 nm is used as receiving light, then the intensity of fluorescence markedly changes with the amount of bran, with the result that the data on the amount of bran provides a high resolution.

In the present invention, taking the above phenomenon into consideration, ultraviolet light is irradiated to rice washing water and then the intensity of fluorescence emitted by ferulic acid in rice washing water, excited by the ultraviolet light, is measured. And the measured values are used as an index for judging the amount of bran in the rice washing water. One way to use the measured values as an index is to compare the measured values with the predetermined standard value so as to evaluate the amount of bran on the sample rice.

As ultraviolet light to which rice washing water is exposed, the light having wave length in the range of 330 to 340 nm is advantageously used as described above, because such light excites the ferulic acid to emit intensive fluorescence. When measuring the intensity of fluorescence obtained using the ultraviolet light having wavelengths in that range, it is advantageous to set the wavelength of receiving fluorescence in the range of 430 to 450 nm, in view of the resolution on the amount of bran as described above.

An apparatus for measuring the amount of bran remaining on rice grains includes a rice washing container, a stirring device, an ultraviolet light source, a fluorophotometer, an ultraviolet light bandpass filter, and a fluorescence bandpass filter. Since the rice washing container is required to perform not only the function of containing polished rice and water and stirring the same, but also the function of receiving ultraviolet light to excite the ferulic acid therein and conducting fluorescence emitted by the ferulic acid to the outside, it is formed of a material, such as quartz, transparent to both ultraviolet light and fluorescence into a 4-face cell. The stirring device is for stirring the sample rice and water in the rice washing container; and in many cases, it is constructed in such a manner as to arrange an impeller in the inside of the rice washing container, fix the impeller to a shaft vertically penetrating the bottom of the container and drive the same with a motor held in the inside of a pedestal which supports the rice washing container. The stirring device may include a control substrate which can set and control the number and time of revolution of the motor.

The ultraviolet light source, fluorophotometer, ultraviolet light bandpass filter and fluorescence bandpass filter, which constitute the apparatus for measuring the amount of bran, are commercially available. The ultraviolet light bandpass filter is arranged between the rice washing container and the ultraviolet light source to limit the wave length of the ultraviolet light to fall in the range of 330 to 340 nm. The fluorescence bandpass filter is arranged between the rice washing container and the fluorophotometer to limit the wave length of the fluorescence received for measurements to fall in the range of 430 to 450 nm.

### BRIEF DESCRIPTION OF THE DRAWINGS

The foregoing and other objects and features of the invention will become more apparent from the following detailed description of preferred embodiments of the invention with reference to the accompanying drawings, wherein:

FIG. 1 is a graphical representation of the intensity of fluorescence emitted by ferulic acid in samples when the samples are exposed to ultraviolet light having different wave lengths;

FIG. 2 is a graphical representation of the intensity of fluorescence emitted by ferulic acid contained in bran when rice washing water containing different amounts of bran are exposed to ultraviolet light having a wave length of 340 nm;

FIG. 3 is a schematic representation of an apparatus in accordance with one embodiment of the present invention which is for carrying out the measurement or evaluation of the amount of bran;

FIG. 4 is a tabular representation of samples which are objects in measuring and evaluating the amount of bran using the apparatus of FIG. 3;

FIG. 5 shows one example of the results of measurements for the samples of FIG. 4;

FIG. 6 shows methods of measuring several items other than the intensity of fluorescence;

FIG. 7 shows the relationship between the turbidity and the amount of dietary fiber; and

FIG. 8 shows the relationship between the intensity of fluorescence and the amount of dietary fiber.

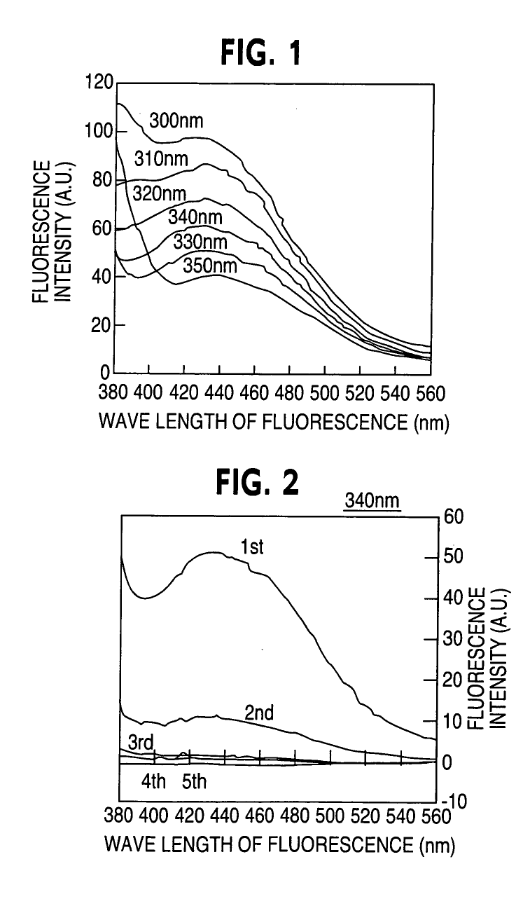

### DESCRIPTION OF THE EMBODIMENTS

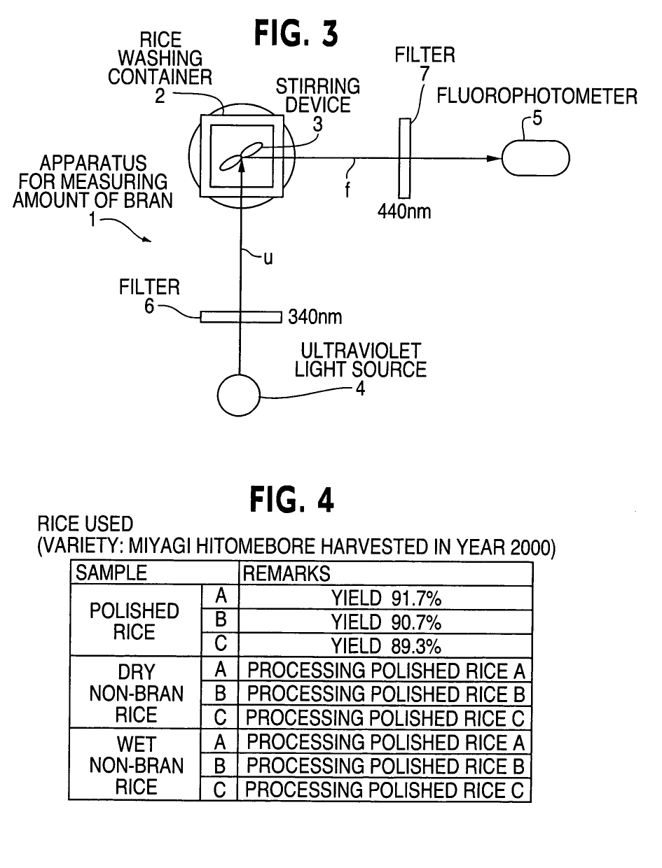

FIG. 3 is a plan view of an apparatus 1 for measuring the amount of bran, which includes a rice washing container 2, a stirring device 3, an ultraviolet light source 4, a fluorophotometer 5, an ultraviolet light bandpass filter 6 and a fluorescence bandpass filter 7. Reference numeral 8 denotes a pedestal whose inside is provided with a motor and a control substrate and whose top is mounted with the rice washing container 2. The stirring device 3 is arranged in a rotatable manner in the inside of the rice washing container 2 near the bottom of the same and the driving shaft of the stirring device 3 is connected to the motor in the pedestal 8.

In this embodiment, a mercury lamp, “AH2-RX” by Olympus Optical Co., Ltd., is used as the ultraviolet light source 4, “C2400-89” by Hamamatsu Photonics Co., Ltd. as the fluorophotometer 5, “MBP340W25” by Olympus Optical Co., Ltd. as the ultraviolet light bandpass filter 6, and “U-MU/FURA” and “MBA510W25” by Olympus Optical Co., Ltd. as the fluorescence light bandpass filter 7. In these filters, the wavelengths of passing light are set to fall in the range of 330 to 340 nm and of 430 to 450 nm, respectively. The path u of ultraviolet light and the path f of fluorescence are made almost perpendicular to each other using shielding or beam-condensing means.

In this apparatus, predetermined polished rice or non-bran rice together with water is put into the rice washing container 2 and stirred, and after the movement of rice grains and water subsides, the rice washing water portion is exposed to ultraviolet light. Of the ultraviolet light emitted from the ultraviolet light source 4, the light with wave lengths in the range of 330 to 340 alone is allowed to pass through the ultraviolet bandpass filter 6 and the rice washing water is exposed to such light.

The fluorescence emitted by ferulic acid in the rice washing water when the rice washing water is exposed to the ultraviolet light is converged toward the fluorophotometer 5 and the fluorescence with wave length in the range of 430 to 450 nm alone is allowed to pass through the fluorescence light bandpass filter 7 and measured.

As shown in FIG. 4, three types of sample rice A, B and C were prepared for each of the polished rice, dry non-bran rice and wet non-bran rice of “Miyagi Hitomebore” harvested in the year 2000. Specifically, first, polished rice A (yield 91.7%), polished rice B (yield 90.7%) and polished rice C (yield 89.3%) of “Miyagi Hitomebore” were prepared, and then three types of sample rice A, B and C as dry non-bran rice and those as wet non-bran rice were prepared by processing the above three types of polished rice, respectively. The dry non-bran rice is rice from which bran is removed without water, whereas the wet non-bran rice is rice from which bran is removed with water in a short time.

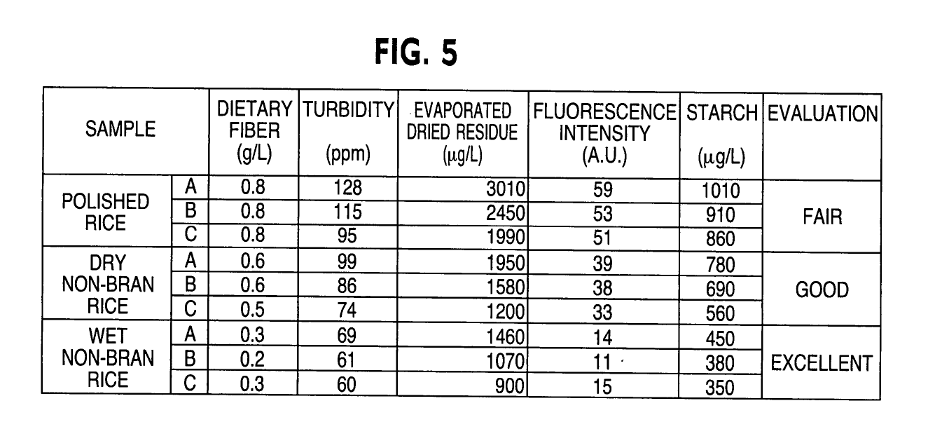

For measurement, 9 types of samples (samples of polished rice A, B and C; samples of dry non-bran rice prepared by processing the polished rice A, B and C; and samples of wet non-bran rice prepared by processing the polished rice A, B and C) were first prepared. Then, 500 gram of sample was taken out from each type of the samples to prepare three samples of rice. Each of these samples of rice were immersed in water of 1 liter and stirred for 10 seconds and then left at a standstill for 60 minutes. Then the resultant supernatant liquid is used for measurement. For each supernatant liquid, the turbidity (ppm), amount of dried residue evaporated (μg/mL), starch (μg/L), dietary fiber (g/L) and intensity of fluorescence (A.U) were measured. The results are summarized in FIG. 5. The results shown in FIG. 5 are the average of measured values for 3 samples of rice prepared for each of 9 types of sample.

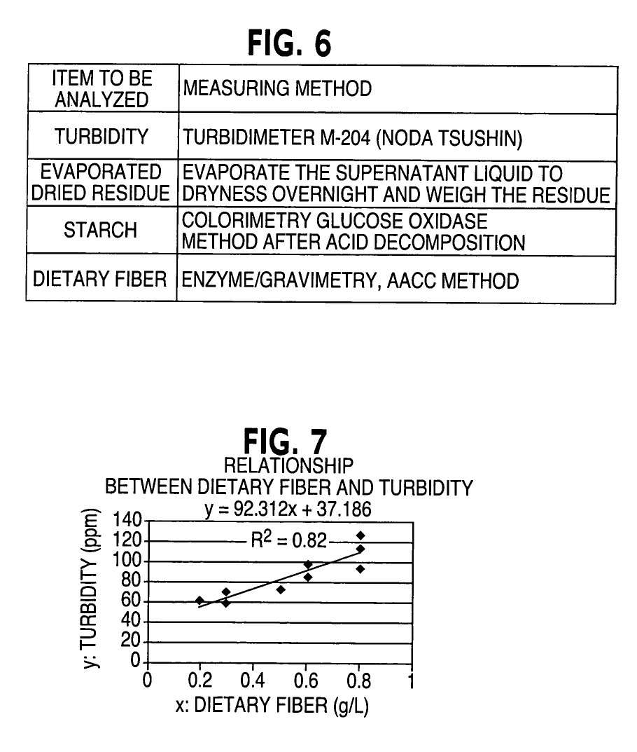

The methods of measuring the above items other than the intensity of fluorescence are shown in FIG. 6. And evaluation for each of 9 types of samples obtained from the measurements is appended to FIG. 5.

Referring to FIG. 5, it is shown that the measured intensity of fluorescence differs widely depending on the types of sample (polished rice, dry non-bran rice, wet non-bran rice). The intensity is in the range of 51 to 59 (A.U) for the polished rice, in the range of 33 to 39 (A.U) for the dry non-bran rice, and in the range of 11 to 15 (A.U) for the wet non-bran rice. Accordingly, when using the above values as an index to evaluate the three types of sample rice for the amount of bran remaining on them, if the sample rice for which the measured intensity of fluorescence is in the range of 30 to 39 (A.U) is regarded as standard (ranked as “good”) the dry non-bran rice can be ranked as “good”, the polished rice as “fair”, and the wet non-bran rice as “excellent”. The ranking or types of evaluation can be set variously. The measured values also differ depending on the degree to which the samples are polished.

The intensity of fluorescence is low in the case of the dry and wet non-bran rice, as compared with the case of the polished rice, because comparatively large part of bran is removed by non-bran rice processing.

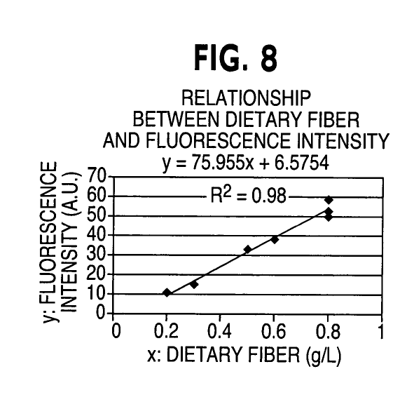

The relation among the measured values of intensity of fluorescence (A.U) indicates relatively close relation among supposed amount of bran, as compared with the relation among the measured values of turbidity (ppm). More specifically, the result of experiments on the correlations between the turbidity (ppm) and the amount of dietary fiber and the correlations between the intensity of fluorescence (A.U) and the amount of dietary fiber has proved that the intensity of fluorescence is more highly related to the amount of the dietary fiber, as shown in FIGS. 7 and 8. In the graph shown in FIG. 7, the vertical axis represents turbidity, and the horizontal axis represents amount of the dietary fiber (g/L). In the relational expression shown in FIG. 7, y represents turbidity and x represents dietary fiber. In the graph shown in FIG. 8, the vertical axis represents intensity of fluorescence, and the horizontal axis represents amount of the dietary fiber (g/L). In the relational expression in FIG. 8, y represents intensity of fluorescence and x represents dietary fiber. In both FIGS. 7 and 8, R² represents a coefficient of correlation, and the closer to 1 the coefficient of correlation becomes, the higher the correlation becomes. In the relational expressions shown in FIGS. 7 and 8, the coefficient x and the constant on the right hand side are all obtained based on the calculation method for coefficients of correlation, more specifically, using the method of least square.

As shown above, since the amount of dietary fiber is almost proportional to the amount of bran, measuring the intensity of fluorescence emitted by ferulic acid is a more effective way in obtaining an index of the amount of bran than measuring the turbidity in obtaining an index of the amount of bran.

Using the measured values as an index of the above described evaluation based on the set standard value is only one example, and the measured values can be used as a basis for operational changeover in controlling machines such as automatic rice polishing machine and automatic rice washing machine.

As described above, according to the present invention, as the intensity of fluorescence emitted by ferulic acid, which is directly related to the amount of bran, is measured, the amount of bran in rice washing water can be measured with higher precision, as compared with the case of the conventional method. Further, the use of the measured results for judging the degree to which rice has been polished and for evaluating the degree to which rice has been processed into non-bran rice enables higher-precision rice polishing control and non-bran rice processing control as well as higher-precision quality indication.

1. A method of measuring the amount of bran in rice washing water with which the rice has been washed, comprising:
measuring the intensity of fluorescence emitted by ferulic acid contained in the rice washing water when the rice washing water is exposed to ultraviolet light and the ferulic acid is excited by the ultraviolet light; and
determining the amount of bran in the rice washing water based on the measured value of the intensity of fluorescence.

2. The method of measuring the amount of bran according to claim 1, wherein the wave length of the ultraviolet light to which the rice washing water is exposed is in the range of 330 to 340 nm and the wave length of the fluorescence whose intensity is to be measured is in the range of 430 to 450 nm.

3. A method of evaluating the amount of bran remaining on sample rice, comprising:
measuring the intensity of fluorescence emitted by ferulic acid, which is contained in rice washing water with which the sample rice has been washed, when the rice washing water is exposed to ultraviolet light; and
determining the amount of bran contained in the sample rice by comparing the measured value of the intensity of fluorescence with the predetermined standard value.

4. The method of evaluating the amount of bran according to claim 3, wherein the wave length of the ultraviolet light to which the rice washing water is exposed is in the range of 330 to 340 nm and the wave length of the fluorescence whose intensity is to be measured is in the range of 430 to 450 nm.

5. An apparatus for measuring the amount of bran, comprising:
a rice washing container formed of a material transparent to both ultraviolet light and fluorescence;
a stirring device for stirring sample rice and water in the rice washing container;
an ultraviolet light source;
a fluorophotometer;
an ultraviolet light bandpass filter arranged between the rice washing container and the ultraviolet light source; and
a fluorescence bandpass filter arranged between the rice washing container and the fluorophotometer;
wherein the ultraviolet light bandpass filter is set to pass light having wave length in the range of 330 to 340 nm and the fluorescence bandpass filter is set to pass light having wavelength in the range of 430 to 450 nm.

6. The apparatus for measuring the amount of bran according to claim 5, wherein the rice washing container is a prismatic four-face quartz cell and the direction in which the fluorophotometer receives fluorescence intersects at said rice washing container almost perpendicularly with the direction in which ultraviolet light is irradiated.
